(19) United States
(12) Patent Application Publication
(10) Pub. No.: US 2021/0196031 A1
(43) Pub. Date: Jul. 1, 2021

(54) Tape Measure Carrying Assembly

(71) Applicant: Jason Unck, Fremont, CA (US)

(72) Inventor: Jason Unck, Fremont, CA (US)

(21) Appl. No.: 16/728,486

(22) Filed: Dec. 27, 2019

(51) Int. Cl. A45F 5/02; G01B 3/1071

(52) U.S. Cl. CPC A45F 5/021; A45F 2200/0575; G01B 2003/1074; G01B 3/1071

(57) ABSTRACT

A tape measure carrying assembly for storing a tape measure includes a strap that is folded over onto itself such that the strap forms a closed loop for receiving a belt worn on a user's pants. Moreover, the strap is stitched to itself to define a first portion of the closed loop and a second portion of the closed loop. The first portion receives the belt on the user's pants. A ring is suspended from the second portion of the closed loop defined by the strap. Additionally, the ring can engage a clip on a tape measure for storing the tape measure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to carrying devices and more particularly pertains to a new carrying device for storing a tape measure.

### (2) Description of Related Art Including Information Disclosed Under 37 CFR 1.97 and 1.98

The prior art relates to carrying devices. The prior art discloses a panel having a slot integrated therein for receiving a belt and a groove therein for engaging a clip of a tape measure. Additionally, the prior art discloses a panel that has a slot therein for receiving a belt and a cage being movably coupled to the panel for storing a claw hammer. The prior art discloses a tool holster that includes a strap that is suspended from a belt and a pocket that is integrated into the strap for storing a tool. The prior art discloses a pager holder that includes a strap folded onto itself to form a single closed loop and an engagement that is attached to the strap for engaging a clip on a pager.

### BRIEF SUMMARY OF THE INVENTION

An embodiment of the disclosure meets the needs presented above by generally comprising a strap that is folded over onto itself such that the strap forms a closed loop for receiving a belt worn on a user's pants. Moreover, the strap is stitched to itself to define a first portion of the closed loop and a second portion of the closed loop. The first portion receives the belt on the user's pants. A ring is suspended from the second portion of the closed loop defined by the strap. Additionally, the ring can engage a clip on a tape measure for storing the tape measure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tape measure carrying assembly according to an embodiment of the disclosure.

FIG. 2 is a front view of an embodiment of the disclosure.

FIG. 3 is a right side view of an embodiment of the disclosure.

FIG. 4 is a perspective in-use view of an embodiment of the disclosure.

### DETAILED DESCRIPTION OF THE INVENTION

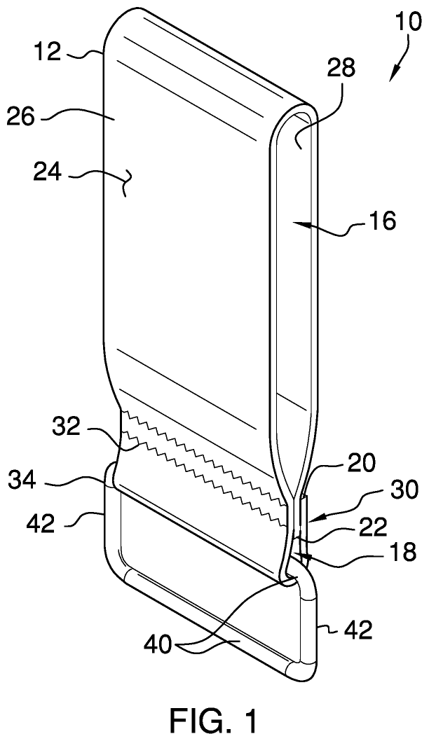

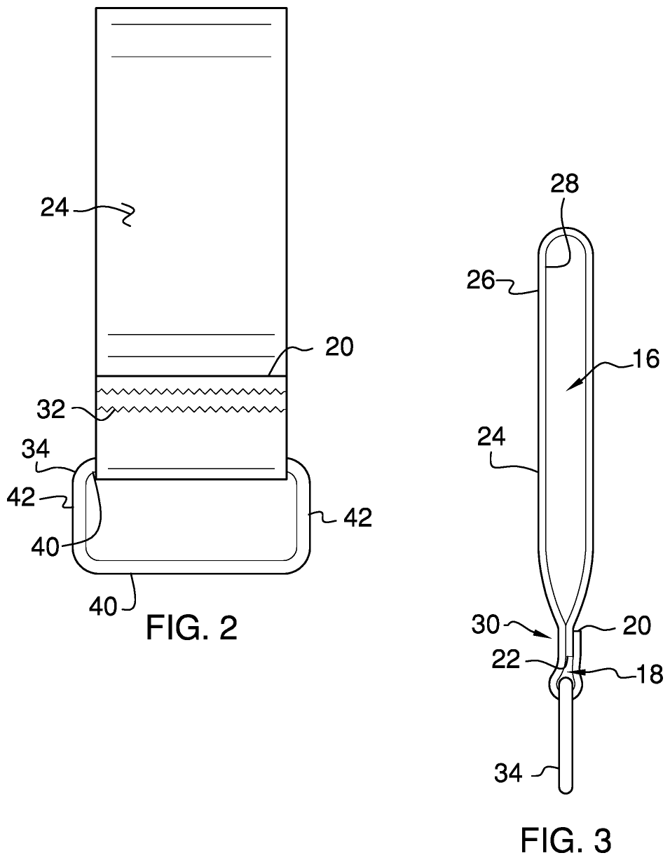

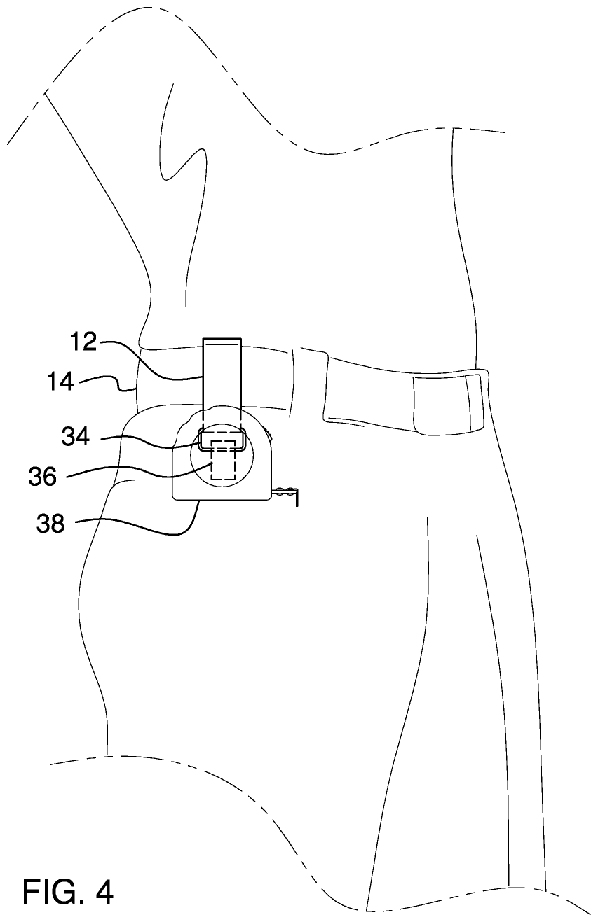

With reference now to the drawings, and in particular to FIGS. 1 through 4 thereof, a new carrying device embodying the principles and concepts of an embodiment of the disclosure and generally designated by the reference numeral 10 will be described.

As best illustrated in FIGS. 1 through 4, the tape measure carrying assembly 10 generally comprises a strap 12 that is folded over onto itself such that the strap 12 forms a closed loop. In this way a belt 14 worn on a user's pants can be extended through the closed loop. The strap 12 is stitched to itself to define a first portion 16 of the closed loop and a second portion 18 of the closed loop. Additionally, the first portion 16 receives the belt 14 on the user's pants. The strap 12 may have a length ranging between approximately 5.0 inches and 7.0 inches and a width ranging between 0.5 inches and 1.0 inch. Additionally, the strap 12 may be comprised of nylon of other similar synthetic and lightweight material.

The strap 12 has a first end 20, a second end 22 and an outer surface 24 extending therebetween, and the outer surface 24 has a first side 26 and a second side 28. The strap 12 is folded onto itself having the first side 26 abutting the second side 28 at a connection point 30 and having the first end 20 being spaced from the second end 22. The stitching 32 extends through the strap 12 and engages the connection point 30 to define the first portion 16 and the second portion 18 of the closed loop. The first portion 16 has a length that is greater than the length of the second portion 18.

A ring 34 is suspended from the second portion 18 of the closed loop defined by the strap 12 to engage a clip 36 on a tape measure 38 for storing the tape measure 38. The ring 34 has a pair of first members 40 extending between a pair of second members 42, and the second members 42 are spaced apart from each other. A respective one of the first members 40 extends through the second portion 18 of the closed loop has a respective one of the first members 40 being spaced from the strap 12 for engaging the clip 36.

In use, the user's belt 14 is extended through the first portion 16 of the closed loop such that the strap 12 is suspended from the user's belt 14. The clip 36 on the tape measure 38 is engaged on the respective first member 40 of the ring 34 to attach the tape measure 38 to the clip 36. In this way the tape measure 38 can be carried without the risk of being dropped. Additionally, the strap 12 eliminates the problem associated with tape measures falling out of tool boxes or tool pouches. In this way the strap 12 and the ring 34 facilitate the tape measure 38 to always be available to a worker on a job site or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A tape measure carrying assembly being configured to be worn on a belt fir having a tape measure being suspended thereon for storage, said assembly comprising:
a strap being folded over onto itself such that said strap forms a closed loop wherein said strap is configured to have a belt worn on a user's pants to be extended therethrough, said strap being stitched to itself to define a first portion of said closed loop and a second portion of said closed loop, said first portion being configured for receiving the belt on the user's pants; and
a ring being suspended from said second portion of said closed loop defined by said strap wherein said ring is configured to engage a clip on a tape measure for storing the tape measure, said ring having a pair of first members extending between a pair of second members, said first members being linear, spaced apart from each other, and parallel to each other, said second members being linear, spaced apart from each other, and parallel to each other such that said ring is a planar rectangle shape, said rectangle shape having rounded corners, a respective one of said first members extending through said second portion of said closed loop having a respective one of said first members being spaced from said strap for engaging the clip.

2. The assembly according to claim 1, wherein said strap has a first end, a second end and an outer surface extending therebetween, said outer surface having a first side and a second side, said strap being folded onto itself having said first side abutting said second side at a connection point and being overlapped wherein said first end is spaced from said second end.

3. The assembly according to claim 2, wherein said stitching extends through said strap and engages said connection point to define said first portion and said second portion of said closed loop, said first portion having a length being greater than the length of said second portion.

4. (canceled)

5. A tape measure carrying assembly being configured to be worn on a belt for having a tape measure being suspended thereon for storage, said assembly comprising:
a strap being folded over onto itself such that said strap forms a closed loop wherein said strap is configured to have a belt worn on a user's pants to be extended therethrough, said strap being stitched to itself to define a first portion of said closed loop and a second portion of said closed loop, said first portion being configured for receiving the belt on the user's pants, said strap having a first end, a second end and an outer surface extending therebetween, said outer surface having a first side and a second side, said strap being folded onto itself having said first side abutting said second side at a connection point and being overlapped wherein said first end is spaced from said second end, said stitching extending through said strap and engaging said connection point to define said first portion and said second portion of said closed loop, said first portion having a length being greater than the length of said second portion; and
a ring being suspended from said second portion of said closed loop defined by said strap wherein said ring is configured to engage a clip on a tape measure for storing the tape measure, said ring having a pair of first members extending between a pair of second members, said first members being linear, spaced apart from each other, and parallel to each other, said second members being linear, spaced apart from each other, and parallel to each other such that said ring is a planar rectangle shape, said rectangle shape having rounded corners, a respective one of said first members extending through said second portion of said closed loop having a respective one of said first members being spaced from said strap for engaging the clip.

6. The assembly according to claim 5, wherein said strap has a length of at least 5.0 inches and not more than 8.0 inches.
